(19) United States
(12) Patent Application Publication
(10) Pub. No.: US 2021/0335121 A1
(43) Pub. Date: Oct. 28, 2021

(54) SLICER CLEANING TIMER AND SHUT-OFF

(71) Applicant: Globe Food Equipment Co., Dayton, OH (US)

(72) Inventors: Edward Brinkman, Tipp City, OH (US); Todd Clem, Dayton, OH (US)

(73) Assignee: Globe Food Equipment Co., Dayton, OH (US)

(21) Appl. No.: 17/241,311

(22) Filed: Apr. 27, 2021

Related U.S. Application Data
(60) Provisional application No. 63/016,773, filed on Apr. 28, 2020.

(51) Int. Cl. G08B 21/24; B26D 5/00

(52) U.S. Cl. CPC G08B 21/245; B26D 2210/02; B26D 5/00

(57) ABSTRACT

A food slicer includes a cleaning timer for providing warnings to a user and renders the slicer inoperable after a period of usage. The period of usage may be established by food regulations. In advance of that period, warnings are provided that remind the user to clean the slicer. Shutting off the slicer for cleaning resets the timer. If the period of usage passes, then the slicer becomes inoperable until the user shuts off the slicer for cleaning, which automatically resets the timer and the slicer then becomes operable.

### PRIORITY

This application claims priority to U.S. Provisional Patent App. No. 63/016,773, filed Apr. 28, 2020, entitled “SLICER CLEANING TIMER AND SHUT-OFF,” the entire contents of which are hereby incorporated by reference.

### TECHNICAL FIELD OF THE INVENTION

The present invention relates to a food processing device, such as a slicer, that includes a timing mechanism for proper cleaning intervals in accordance with food regulations.

### BACKGROUND

Food preparation or food processing devices may be subject to certain regulations. Specifically, the Food and Drug Administration (“FDA”) has regulations for usage and operation of such devices. A food slicer may be subject to a regulation that requires cleaning after a period of usage. The regulation may require that the device be cleaned before that period of usage expires. For example, the Hazard Analysis and Critical Control Point (“HACCP”) or the FDA food code states that food contact surfaces, including slicers, should be cleaned and sanitized at least every four hours and that food contact surfaces should be disassembled before cleaning and sanitizing when being used at room temperature. The schedule may be reduced in frequency when being used in a refrigerated environment. Compliance with the requirements and regulations can be difficult for the user, so improvements in operation of the slicer are needed to assist with or ensure compliance.

### BRIEF SUMMARY

The present invention relates to a method, system or apparatus and/or computer program product for an improved food processing device, such as a slicer, that provides alerts or warnings to a user regarding cleaning requirements and automatically shuts off or requires a reset for cleaning. Food regulations may require a certain cleaning interval. For example, a slicer may be required to be cleaned every four hours to comply with FDA regulations. The slicer may implement a warning system with periodic notifications as the interval time approaches. The slicer can automatically become inoperable or shut off if the user fails to shut off the slicer for cleaning.

The food slicer includes a cleaning timer for providing warnings to a user and renders the slicer inoperable after a period of usage. The period of usage may be established by food regulations and in advance of that period of usage warnings are provided for the user to clean the slicer. Shutting off the slicer for cleaning resets the timer. If the period of usage passes, then the slicer becomes inoperable until the user shuts off the slicer for cleaning, which automatically resets the timer and the slicer becomes operable. According to one embodiment, the timing mechanism, inoperability, and other functions may be implemented in a computer program being loadable in a memory of a computer, wherein the computer program is adapted to carry out the steps of the methods described herein.

According to one embodiment, the timing mechanism, inoperability, and other functions may be implemented in a computer program being loadable in a memory of a computer, wherein the computer program is adapted to carry out the steps of the methods described herein.

The embodiments include a method for providing warnings to a user for cleaning a food processing device that includes detecting an initial usage of the device; starting a timer for a usage period; providing, when the device has not been reset, a first warning to the user in advance of the usage period; preventing, when the device has not been reset, usage of the device after expiration of the usage period; and restarting the timer when the device has been reset. The first warning displays an amount of time before the usage period. The amount of time is customizable. The reset of the device includes removing a power supply by unplugging the device and the initial usage is reset after the restarting of the timer. The method further includes providing, when the device has not been reset, a second warning to the user in advance of the usage period, wherein the first warning is provided before the second warning. The first warning displays an amount of time before the usage period and the second warning displays an amount of time before the usage period that is less than the amount of time before the usage period of the first warning. The amount of time before the usage period for both the first warning and the second warning are customizable. The usage period includes an amount of time required by regulation for cleaning. The regulation includes a Food and Drug Administration regulation. The usage period is customizable. The resetting of the device is needed for the cleaning. The first warning includes a display that displays an amount of time before expiration of the usage period.

The embodiments further include a food slicer that includes a detector for determining when an initial slice is performed; a timer for starting a countdown for a usage period, wherein the usage period includes an amount of time that can pass before the food slicer is cleaned after the initial slice; and a warning component for providing warnings before the usage period expires. The food slicer prevents operation after the usage period if the food slicer has not been removed from a power supply. The usage period includes an amount of time required by regulation for cleaning. The usage period may be 4 hours. The removal from the power supply includes unplugging the food slicer. The warning component includes a display that displays instructions for resuming operation that include displaying instructions for unplugging the food slicer. The warning component includes a display that displays an amount of time before expiration of the usage period. The warnings include a 30 minute warning before expiration of the usage period and a 15 minute warning before expiration of the usage period.

### BRIEF DESCRIPTION OF THE DRAWINGS

The figures illustrate principles of the invention according to specific embodiments. Thus, it is also possible to implement the invention in other embodiments, so that these figures are only to be construed as examples. Moreover, in the figures, like reference numerals designate corresponding modules or items throughout the different drawings.

FIG. 1 illustrates a block diagram of a slicer.

FIG. 2 illustrates a block diagram of electronics of the slicer.

FIG. 3 illustrates a first flow process for a slicer.

FIG. 4 illustrates a second flow process for a slicer.

### DETAILED DESCRIPTION OF THE DRAWINGS AND PREFERRED EMBODIMENTS

By way of introduction, the disclosed embodiments relate to a cleaning timer being integrated into the electronics of a slicer which is used to discontinue the operation of the slicer so that planned and required cleaning can be performed. The timer can be used for determining when to issue warnings to a user as well as the timing for stopping operation. The operation stoppage or disabling of the slicer may require the user to unplug the slicer, which may be a prerequisite for slicer cleaning.

FIG. 1 illustrates a block diagram of a slicer system 100. The slicer system 100 includes a slicer 102 that is operated by a user 101. The user 101 can be a customer or purchaser of the slicer 102 that utilizes its slicing functionality. The user 101 may be responsible for cleaning the slicer 102.

The slicer 102 may be deli slicer, such as those described in U.S. Pat. No. 10,207,418 entitled “PRODUCT SLICER AND AUTOMATIC SLICER ENGAGEMENT MECHANISM”; U.S. Pat. No. 10,589,439 entitled “BLADE MOUNTING AND REMOVAL TOOL, SYSTEM, AND PRODUCT SLICER”; and U.S. Pat. Pub. No. 2017/0232629 entitled “PRODUCT SLICER”, each of which is hereby incorporated by reference. Exemplary slicers further include the GLOBE PREMIUM HEAVY-DUTY MANUAL SLICER Model #S13 or Model #SG13, or the GLOBE PREMIUM HEAVY-DUTY AUTOMATIC SLICER Model #S13A or Model #SG13A. Although the embodiments shown and described herein relate to a slicer, it should be appreciated that the embodiments may apply to other devices. Specifically, the embodiments may apply to other food processing and food production devices, of which a slicer is merely one example.

The slicer 102 receives power from a power supply 11. The power supply 11 may be provided to the slicer 102 through a power interface 110. The power interface 110 may merely be a plug that is plugged into a wall outlet, which acts as the power supply 111. The power interface 110 may require the power supply 111 to be cut off for cleaning. Power being cut off may just be the user 101 unplugging the power cord. As discussed below, the timer may be reset upon the power cord being unplugged. In other words, the power interface 110 may be used for determining when the timer can be reset.

The power interface 110 may further include power control features. For example, in order to render the slicer 102 inoperable, the power may be cut off in one embodiment by the power interface 110. In other embodiments, the power to the slicer 102 may be maintained but the operation of the device may be disabled. In such an embodiment, the slicer power may be maintained to continue to provide a display notification that notifies the user that the device is due for a cleaning and must be removed from the power supply 111.

The slicer 102 may include a detector 104 component that detects usage of the slicer 102. The timer that sets the usage period begins upon detection of usage because the regulations require cleaning after within a certain period (i.e. usage period) after usage. The usage period does not refer to constant or consistent usage, rather even a single use may have the requirement that within that period, the slicer must be cleaned.

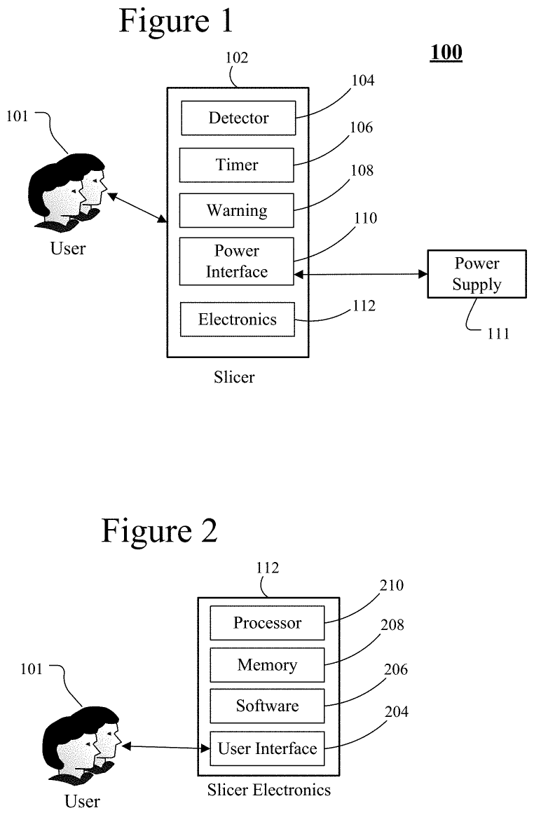

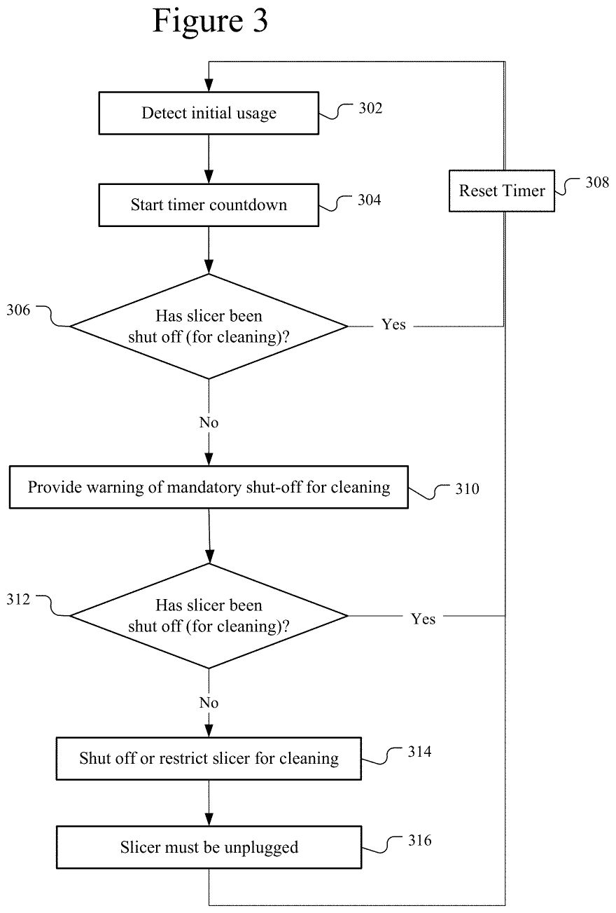

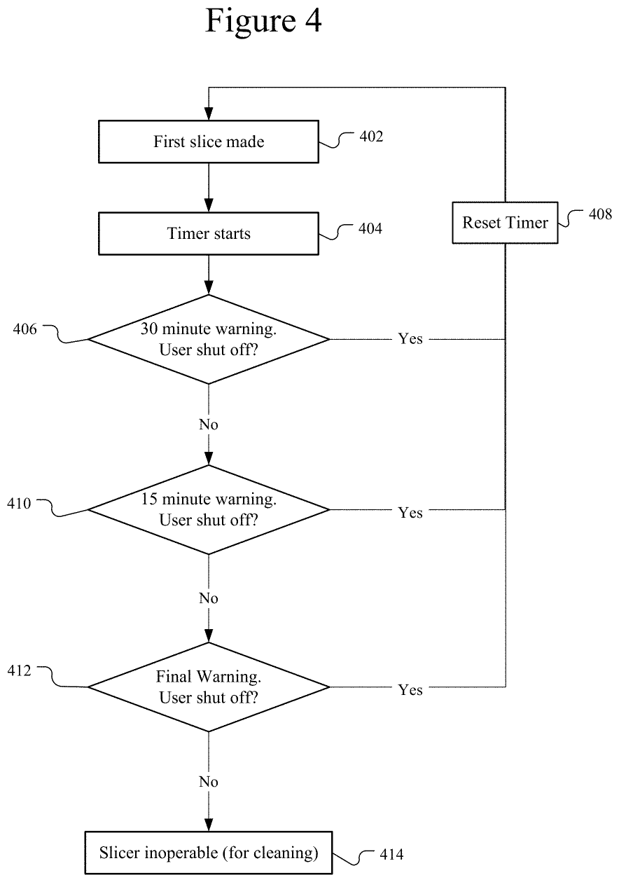

The slicer 102 may further include a timer 106 component that measures the usage period. The timer 106 can also be for measuring a time before one or more warnings 108 are provided to the user 101. The warnings 108 may be in advance of expiration of the usage period, after which the slicer may be rendered inoperable or without power. FIGS. 3-4 describe embodiments in which a slice is detected by the detector 104 for starting the timer 106 and for providing warnings 108. The detector 104, the timer 106, the power interface 110, and/or the warnings 108 may be implemented through the electronics 112. The electronics 112 are further described with respect to FIG. 2.

FIG. 2 illustrates a block diagram of the electronics 112 of the slicer 102. The electronics 112 may be referred to as a computing device, processor, circuit board, chip, or microcomputer through which computations or processes are performed. In one embodiment, the electronics 112 may be software that runs on a computing device as shown in FIG. 2. The electronics 112 may include a processor 210, a memory 208, software 206 and/or a user interface 204. In alternative embodiments, the electronics 112 may be multiple devices to provide different functions and it may or may not include all of the user interface 204, the software 206, the memory 208, and/or the processor 210. For example, the user interface 204 may be a display, which may be separate from the electronics 112.

The slicer 102 may include a user interface 204 for providing information to the user 101. In one embodiment, the user interface 204 may be a display coupled with the processor 210 and configured to display an output from the processor 210. The display (not shown) may be a liquid crystal display (LCD), an organic light emitting diode (OLED), a flat panel display, a solid state display, a cathode ray tube (CRT), or other now known or later developed display device for outputting determined information. The display may act as an interface for the user to see the functioning of the processor 210, or as an interface with the software 206 for providing data. In alternative embodiments, the user interface 204 may also provide a mechanism for the user 101 to interact with the slicer 102, such as by providing commands with a user input. The user input may allow the user 101 to turn the timer and shut-off feature on or off, or provide adjustments to the features, such as frequency and type of warnings and/or adjustments to the usage period, or adjustments to the time intervals in which the warnings are displayed. The warnings may also be customizable in terms of type of display, the text of the display/instructions, or type audio indication. The user 101 may be able to shorten the usage period in order to be extra cautious in following the regulations. In some embodiments, the user interface 204 may include buttons, touch screen display, a keyboard, keypad or a cursor control device, such as a mouse, or a joystick, remote control or any other device operative to allow a user or administrator to interact with the electronics 112.

The processor 210 in the electronics 112 may include a central processing unit (CPU), a graphics processing unit (GPU), a digital signal processor (DSP) or other type of processing device. The processor 210 may be one or more general processors, digital signal processors, application specific integrated circuits, field programmable gate arrays, servers, networks, digital circuits, analog circuits, combinations thereof, or other now known or later developed devices for analyzing and processing data. The processor 210 may operate in conjunction with a software program (i.e. software 206), such as code generated manually (i.e., programmed). The software 206 may include functionality for the timer mechanism, for providing warnings to the user, and for preventing operation of the slicer upon expiration of the timer.

The processor 210 may be coupled with the memory 208, or the memory 208 may be a separate component. The software 206 may be stored in the memory 208. The memory 208 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 208 may include a random access memory for the processor 210. Alternatively, the memory 208 may be separate from the processor 210, such as a cache memory of a processor, the system memory, or other memory. The memory 208 is operable to store instructions executable by the processor 210.

The functions, acts or tasks illustrated in the figures (e.g. FIGS. 3-4) or described herein may be performed by the programmed processor executing the instructions stored in the software 206 or the memory 208. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 210 is configured to execute the software 206.

The electronics 112 may be used for implementing the processes shown in the embodiments of FIGS. 3-4. FIG. 3 illustrates a first flow process for a slicer. In block 302, initial usage of the slicer is detected. This may be with the detector 104 shown in FIG. 1 and/or by the electronics 112. The detection of usage triggers the start of the timer countdown in block 304. The timer countdown is for tracking the usage period so that the slicer can be cleaned at least within the usage period. The length of the usage period can vary, and may be established by the regulations. For example, the FDA regulation for slicing may require cleaning within four hours from the initial usage.

The timer continues to track the usage period until the device has been shut off for cleaning in block 306. If the slicer 102 has been shut off, then the countdown timer is reset in block 308. The countdown timer will then be started again upon the next usage following a shut off or cleaning. If the slicer 102 has not been shut off, then a warning is provided in block 310.

The warning may be a displayed notification or an audio notification. The displayed notification may be a warning that provides an estimated time remaining until there is a mandatory shut off or disabling of operation. In some embodiments, the warning may be displayed until the user 101 shuts off the slicer or may require the user to acknowledge the warning. The warning may state: “ATTENTION: X MINUTES TO CLEAN SLICER” where X is the number of minutes until the usage period expires. In some embodiments, the warning may also include an audio notification (e.g. alarm) that ensures that the user 101 is aware of the impending expiration of the usage period. The warning may continue until the user acknowledges that they are aware of the time left.

After the warning, if the slicer 102 has not been shut off in block 312, then the slicer is restricted for cleaning in block 314. In one embodiment, the slicer cannot require a user to perform a cleaning operation but can prevent usage until the slicer is unplugged. The display of the slicer may include instructions for the user to clean the slicer. This display may be cleared (and the timer reset) upon unplugging the slicer. In other words, the user 101 can reset the timer by unplugging the slicer as in block 316, which then resets the countdown timer in block 308. In some embodiments, unplugging the slicer may be a prerequisite for a cleaning process. In alternative embodiments, there may be other options for prerequisites for cleaning, such as cutting off the power supply 111 with the power interface 110.

The disabling of the slicer may be accomplished through the electronics 112, such as by disabling features. This enables the warnings to be displayed and instructions provided to the user for cleaning and unplugging the slicer to regain operation. In some embodiments, this operation may be through diagnostics or through a dip-switch on the electronics 112. Alternatively, the disabling may be through the power interface 110 of the slicer.

FIG. 4 illustrates a second flow process for a slicer. In block 402, a first slice is made with the slicer and the timer starts in block 404. 30 minutes before the usage period expires, there is a 30 minute warning to see if the user has shut off the slicer in block 406. If the slicer has been shut off, then the timer is reset in block 408. If the slicer has not been shut off, then there may be a 15 minute warning to see if the user has shut off the slicer in block 410. Multiple warnings may be necessary to ensure the that the slicer does not turn off in the middle of an operation. If the slicer has been shut off, then the timer is reset in block 408. If the slicer has not been shut off, then there may be a final warning to see if the user has shut off the slicer in block 412. The final warning (and/or any of the warnings) may include instructions such as “ATTENTION: UNPLUG SLICER AND CLEAN TO USE.” If the slicer has been shut off, then the timer is reset in block 408. If the slicer has not been shut off, then the slicer can be disabled for use in block 414. The disabling of the slicer occurs after the usage period has passed from the first slice without the user shutting off the slicer. Once the timer has been reset in block 408, the next slice made with the slicer starts a new timer in blocks 402/404.

The meaning of specific details should be construed as examples within the embodiments and are not exhaustive or limiting the invention to the precise forms disclosed within the examples. One skilled in the relevant art will recognize that the invention can also be practiced without one or more of the specific details or with other methods, implementations, modules, entities, datasets, etc. In other instances, well-known structures, computer-related functions or operations are not shown or described in detail, as they will be understood by those skilled in the art.

The discussion above is intended to provide a brief, general description of a suitable computing environment (which might be of different kind like a client-server architecture or an Internet/browser network) in which the invention may be implemented. The invention will be described in general context of computer-executable instructions, such as software modules, which might be executed in combination with hardware modules, being executed by different computers in the network environment. Generally, program modules or software modules include routines, programs, objects, classes, instances, components, data structures, etc., that perform particular tasks or implement particular abstract data types. Computer-executable instructions, associated data structures and program modules represent examples of the program code means for executing steps of the method described herein. The particular sequence of such executable instructions, method steps or associated data structures only represent examples of corresponding activities for implementing the functions described therein. It is also possible to execute the method iteratively.

Those skilled in the art will appreciate that the invention may be practiced in a network computing environment with many types of computer system configurations, including personal computers (PC), hand-held devices (for example, smartphones), multi-processor systems, microprocessor-based programmable consumer electronics, network PCs, minicomputers, mainframe computers, laptops and the like. Further, the invention may be practiced in distributed computing environments where computer-related tasks are performed by local or remote processing devices that are linked (either by hardwired links, wireless links or by a combination of hardwired or wireless links) through a communications network. In a distributed computing environment, program modules may be located in local or remote devices, memory systems, retrievals or data storages.

Generally, the method according to the invention may be executed on one single computer or on several computers that are linked over a network. The computers may be general purpose computing devices in the form a conventional computer, including a processing unit, a system memory, and a system bus that couples various system components including system memory to the processing unit. The system bus may be any one of several types of bus structures including a memory bus or a memory controller, a peripheral bus and a local bus using any of a variety of bus architectures, possibly such which will be used in clinical/medical system environments. The system memory includes read-only memory (ROM) and random access memories (RAM). A basic input/output system (BIOS), containing the basic routines that have the functionality to transfer information between elements within the computer, such as during start-up, may be stored in one memory. Additionally, the computer may also include hard disc drives and other interfaces for user interaction. The drives and their associated computer-readable media provide non-volatile or volatile storage of computer executable instructions, data structures, program modules and related data items. A user interface may be a keyboard, a pointing device or other input devices (not shown in the figures), such as a microphone, a joystick, a mouse. Additionally, interfaces to other systems might be used. These and other input devices are often connected to the processing unit through a serial port interface coupled to system bus. Other interfaces include a universal serial bus (USB). Moreover, a monitor or another display device is also connected to the computers of the system via an interface, such as video adapter. In addition to the monitor, the computers typically include other peripheral output or input devices (not shown), such as speakers and printers or interfaces for data exchange. Local and remote computer are coupled to each other by logical and physical connections, which may include a server, a router, a network interface, a peer device or other common network nodes. The connections might be local area network connections (LAN) and wide area network connections (WAN) which could be used within intranet or internet. Additionally, a networking environment typically includes a modem, a wireless link or any other means for establishing communications over the network.

Moreover, the network typically comprises means for data retrieval, particularly for accessing data storage means like repositories, etc. Network data exchange may be coupled by means of the use of proxies and other servers.

The example embodiments are to be considered in all respects only as illustrative and not restrictive. The scope of the invention is, therefore, indicated by the appended claims rather than by this description. All changes which come within the meaning and range of equivalency of the claims are to be embraced within their scope.

We claim:

1. A method for providing warnings to a user for cleaning a food processing device, the method comprising:
detecting an initial usage of the device;
starting a timer for a usage period;
providing, when the device has not been reset, a first warning to the user in advance of the usage period;
preventing, when the device has not been reset, usage of the device after expiration of the usage period; and
restarting the timer when the device has been reset.

2. The method of claim 1, wherein the first warning displays an amount of time before the usage period.

3. The method of claim 2, wherein the amount of time is customizable.

4. The method of claim 1, wherein the reset of the device comprises removing a power supply by unplugging the device.

5. The method of claim 1, wherein the initial usage is reset after the restarting of the timer.

6. The method of claim 1, further comprising:
providing, when the device has not been reset, a second warning to the user in advance of the usage period, wherein the first warning is provided before the second warning.

7. The method of claim 6, wherein the first warning displays an amount of time before the usage period and the second warning displays an amount of time before the usage period that is less than the amount of time before the usage period of the first warning.

8. The method of claim 7, wherein the amount of time before the usage period for both the first warning and the second warning are customizable.

9. The method of claim 1, wherein the usage period comprises an amount of time required by regulation for cleaning.

10. The method of claim 9, wherein the regulation comprises a Food and Drug Administration regulation.

11. The method of claim 9, wherein the usage period is customizable.

12. The method of claim 9, wherein the resetting of the device is needed for the cleaning.

13. The method of claim 8, wherein the first warning comprises a display that displays an amount of time before expiration of the usage period.

14. A food slicer comprising:
a detector for determining when an initial slice is performed;
a timer for starting a countdown for a usage period, wherein the usage period comprises an amount of time that can pass before the food slicer is cleaned after the initial slice; and
a warning component for providing warnings before the usage period expires;
wherein the food slicer prevents operation after the usage period if the food slicer has not been removed from a power supply.

15. The food slicer of claim 14, wherein the usage period comprises an amount of time required by regulation for cleaning.

16. The food slicer of claim 15, wherein the usage period comprises 4 hours.

17. The food slicer of claim 14, wherein the removal from the power supply comprises unplugging the food slicer.

18. The food slicer of claim 17, wherein the warning component comprises a display that displays instructions for resuming operation that include displaying instructions for unplugging the food slicer.

19. The food slicer of claim 14, wherein the warning component comprises a display that displays an amount of time before expiration of the usage period.

20. The food slicer of claim 14, wherein the warnings comprise a 30 minute warning before expiration of the usage period and a 15 minute warning before expiration of the usage period.
